(19) United States
(12) Patent Application Publication
(10) Pub. No.: US 2014/0075823 A1
(43) Pub. Date: Mar. 20, 2014

(54) FISHING WEIGHT HAVING OPTIMIZED BUOYANCY CHARACTERISTICS

(71) Applicants: Dean Messersmith, Bremerton, WA (US); Bill Henry, Bremerton, WA (US)

(72) Inventors: Dean Messersmith, Bremerton, WA (US); Bill Henry, Bremerton, WA (US)

(21) Appl. No.: 14/028,473

(22) Filed: Sep. 16, 2013

Related U.S. Application Data
(60) Provisional application No. 61/701,703, filed on Sep. 16, 2012.

(51) Int. Cl. A01K 95/00

(52) U.S. Cl. CPC A01K 95/00
USPC 43/43.14; 43/44.9

(57) ABSTRACT

The present disclosure relates generally to fishing sinkers and weights, and more specifically to a fishing weight having optimized buoyancy characteristics such that the weight tends to rest on top of foreign submerged material, e.g. water-milfoil, rather than sinking into and becoming entangled in the material. In a preferred embodiment, the fishing weight comprises a cylindrically shaped body made of a synthetic cork material, e.g. a synthetic wine bottle cork, which on its own tends to float in water. The fishing weight further comprises a weight element inserted into the body to achieve optimal buoyancy characteristics of the apparatus as a whole. Finally, each of two opposing ends of the cylindrically shaped body have attached thereto means for connecting the fishing weight to at least one of fishing line and/or a leader line having a hook at the end thereof.

### CROSS-REFERENCE TO RELATED APPLICATIONS

The present application claims the benefit of U.S. Provisional Patent Application No. 61/701,703 filed Sep. 16, 2012, entitled “Fishing Weight Having Optimized Buoyancy Characteristics,” which is incorporated herein by reference in their entirety as if fully set forth herein.

### FIELD OF THE DISCLOSURE

The present disclosure relates generally to fishing sinkers and weights, and more specifically to a fishing weight having optimized buoyancy characteristics such that the weight tends to rest on top of foreign submerged material, e.g. water-milfoil, rather than sinking into and becoming entangled in the material.

### BACKGROUND

This section provides background information related to the present disclosure which is not necessarily prior art to the claims in this application and are not admitted to be prior art by inclusion in this section.

In order to catch fish, a fisherman (a.k.a. angler) must possess the ability to deliver a baited hook into the vicinity of the sought after fish. When fishing from the shore, a fisherman must be able to cast the baited hook (tackle) out over the water so that it can be reeled in through the vicinity of the fish. In some situations, e.g. where the desired vicinity is far from the shore, reaching the vicinity is quite difficult. Wind resistance on the lure and the fishing line exacerbate this difficulty. In order to counter the effects of wind resistance, fishermen often find it necessary to add weight to a fishing line thereby increasing the inertia of the line during casting and assisting in the delivery of the tackle to the optimal vicinity of the sought after fish. While the addition of weight to the fishing line is productive toward catching fish in that counters the effects of wind resistance, it may also negatively affect performance by causing the line to sink too rapidly, too deep, or both. Because fish often seek cover by residing in or around underwater materials, e.g. water milfoil and/or sunken timber, a line that sinks too rapidly and/or deep will often become entangled in these material causing the line to snap and costly tackle to be lost. Moreover, the time it takes to reconfigure a broken line reduces the time a fisherman is actively fishing and, accordingly, the probability of a successful outing.

U.S. Pat. No. 3,641,699 to Mattarocci, dated Feb. 15, 1972, and fully incorporated by reference herein, discloses a purportedly snag free fishing weight for attaching to the fishing line and leader. The weights are long and thin to prevent fouling as the weight is dragged through underwater material. In one form of the invention, a snap-on hook projects from one end to accept a leader line and a line receiving bore or groove at the opposite end. While the slender shape of the Mattarocci weight may prevent fouling, it does not aim to prevent the weight, line, and/or tackle from entering and being dragged through underwater material. Therefore, a fishing weight having optimized buoyancy characteristics such that the weight tends to rest on top of foreign submerged material, e.g. water-milfoil, rather than sinking into and becoming entangled in the material is desirable.

U.S. Pat. App. Pub. No. US 2008/0086930 A1 to Swaney, published Apr. 17, 2008, and fully incorporated by reference herein, discloses a buoyancy compensating fishing weight apparatus including a weight, a hollow cylinder, and a length of wire or line disposed through each of the weight and the cylinder. The hollow cylinder is slightly elongate, waterproof, and buoyant. The weight is attached at a lower end of the hollow cylinder and a swivel or eyelet is attached at an opposite upper end of the hollow cylinder. While the overall volume-to-mass ratio of the Swaney weight may provide buoyancy compensation to the apparatus, because the weight is attached at an end of the hollow cylinder the equilibrium orientation of the apparatus is such that the apparatus rests with the axis defined by the hollow cylinder in a generally vertical position; hence, the Swaney weight apparatus does not aim to travel through the water in a position that reduces fouling as the weight is dragged through underwater material.

U.S. Pat. No. 3,852,906 to LaForce, dated Dec. 10, 1974, and fully incorporated by reference herein, discloses a fishing sinker having an elongated and hollow cylindrical-shaped body that is closed off at its ends to define airspace therein, and carries weight or ballast means at its lower end. A ring-like connector is mounted on the body for up and down movement there along, and means for retaining the ring in one of a selected group of positions to provide different point for connecting a fishing line thereto. Similar to the Swaney weight, the LaForce sinker aims to provide buoyancy to the sinker to increase its efficiency in use but does not aim to travel through the water in a position that reduces fouling as the weight is dragged through underwater material. Therefore, a fishing weight having the aforementioned optimized buoyancy characteristics and also a shape and equilibrium orientation that tends to reduce fouling is desirable.

For the foregoing reasons, there is a need for a fishing weight having optimized buoyancy characteristics such that the weight tends to rest on top of foreign submerged material, e.g. water-milfoil, rather than sinking into and becoming entangled in the material, and which has a streamlined shape and a generally neutral equilibrium orientation such that even when the weight is dragged through underwater material the probability of fouling is minimal.

### SUMMARY

The present disclosure relates generally to fishing sinkers and weights, and more specifically to a fishing weight having optimized buoyancy characteristics such that the weight tends to rest on top of foreign submerged material, e.g. water-milfoil, rather than sinking into and becoming entangled in the material.

In a preferred embodiment, the fishing weight comprises a cylindrically shaped body made of a synthetic cork material, e.g. a synthetic wine bottle cork, which on its own tends to float in water. The fishing weight further comprises a weight element inserted into the body to achieve optimal buoyancy characteristics of the apparatus as a whole. Finally, each of two opposing ends of the cylindrically shaped body have attached thereto means for connecting the fishing weight to at least one of fishing line and/or a leader line having a hook at the end thereof. In other embodiments, the fishing weight having optimized buoyancy characteristics comprises means for adjusting the buoyancy thereof.

### BRIEF DESCRIPTION OF THE DRAWINGS

These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Furthermore, the drawings included herein are considered by the applicant to be informal.

FIG. 1 is a side view, in accordance with a first embodiment of the fishing weight, of a cylindrical buoyant body of the fishing weight having a swivel connector attached at each of two opposing ends.

FIG. 2 is a sectional view taken along the line A-A of FIG. 1, looking in the direction of the arrows, showing a weight within the cylindrical buoyant body and pins for securing the swivels to the body at the opposing ends.

FIG. 3 is a side view, in accordance with a second embodiment of the fishing weight, of a cylindrical buoyant body of the fishing weight having a swivel connector attached at each of two opposing ends and a profile for reducing drag resistance and fouling as the fishing weight is dragged through water, e.g. a chamfered or rounded edge.

FIG. 4 is a sectional view taken along the line B-B of FIG. 3, looking in the direction of the arrows, showing a weight within the cylindrical buoyant body and pins for securing the swivels to the body at the opposing ends.

FIG. 5 is a side view, in accordance with a third embodiment of the fishing weight, of two semi-cylindrical components of the fishing weight which together form a cylindrical buoyant body of the fishing weight. Each semi-cylindrical component has a grooved region for accepting a band which joins the components. Swivel connectors protrude at opposite ends.

FIG. 6 is an exploded side view, in accordance with the third embodiment of FIG. 5, showing the semi-cylindrical components separated and exposing a weight which is normally within the body. Attached at opposite ends of the weight are swivel connectors. Bands joining the components are not shown in FIG. 6.

FIG. 7 is a side view, in accordance with a fourth embodiment of the fishing weight, of a cylindrical buoyant body of the fishing weight having a swivel connector at each of two opposing ends.

FIG. 8 is a sectional view taken along the line C-C of FIG. 7, looking in the direction of the arrows, showing a hollow space containing removable weights, e.g. lead BB's, within the cylindrical buoyant body. At least one of the swivel connector is removable to allow for the amount of weight within the hollow space to be adjusted.

### DETAILED DESCRIPTION

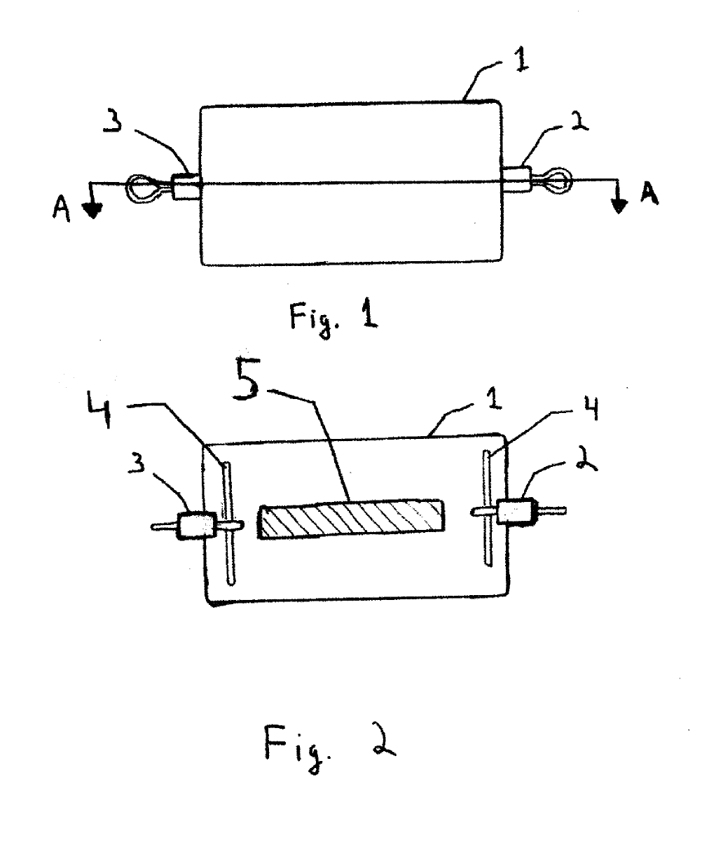

The present disclosure relates generally to fishing sinkers and weights, and more specifically to a fishing weight having optimized buoyancy characteristics such that the weight tends to rest on top of foreign submerged material, e.g. water-milfoil, rather than sinking into and becoming entangled in the material. Specific details of certain embodiments of the invention are set forth in the following description and in FIGS. 1-8 to provide a thorough understanding of such embodiments. The fishing weight having optimized buoyancy characteristics may have additional embodiments, may be practiced without one or more of the details described for any particular described embodiment, or may have any detail described for one particular embodiment practiced with any other detail described for another embodiment.

As used herein, the term “buoyancy” is defined as any upward force exerted by a fluid, e.g. water and/or air, opposing the weight of an immersed object. Referring to the fishing weight as having optimized buoyancy does not necessarily mean that the fishing weight has a tendency to stay afloat in water; it simply means that an optimal balance between the weight of the object and the upward force exerted on it by the water has been achieved. It is worth noting that an object that tends to sink in water does still have certain buoyancy forces exerted on it. The buoyancy of the fishing weight disclosed herein may be set such that: the weight floats at the surface of water, the weight is neutrally buoyant so that is tends neither to float nor to sink in water, or so that the weight sinks at a desired rate. In a preferred embodiment the fishing weight disclosed herein does tend to sink, although barely, such that the weight rests on top of milfoils rather than continuing to sink once contacting the milfoil.

FIG. 1 is a side view, in accordance with a first embodiment of the fishing weight, showing a cylindrical buoyant body 1 of the fishing weight. In a preferred embodiment, the cylindrical body 1 comprising a synthetic cork material which on its own does tend to float in water. Synthetic cork serves as the ideal material selection in most applications due to the high level of control and consistency that can be achieved over modern manufacturing processes, i.e. numerous body “blanks” can easily be manufactured with tight tolerances regarding the volume, weight, and density of the blank. However, any other type of material known in the art and suitable for this purpose may be selected. For example, natural cork may be selected to reduce the environmental effects of losing a fishing weight. Moreover, the body 1 is not required to be cylindrical in shape. For example, its shape may be square, spherical, or any other shape. In the illustrated embodiment, the body 1 has two opposite ends at which there are means for connecting the fishing weight to a fishing line and/or a leader line. Preferably, the aforementioned means comprise a first barrel swivel 2 and a second barrel swivel 3. Any of the many types of barrel swivels are known in the art and suitable for this purpose may be selected. Preferably, at least one of the first barrel swivel 2 and second barrel 3 comprise a means to easily remove and/or install a leader line, e.g. Duo Lock Snaps. Such a feature will allow for quickly and easily changing leader lines with different fishing tackle attached thereto.

FIG. 2 is a sectional view taken along the line A-A of FIG. 1, looking in the direction of the arrows, showing a weight 5 within the cylindrical buoyant body and pins 4 for securing the swivels to the body at the opposing ends. In the illustrated embodiment, each of the two pins 4 are embedded within the body 1 and protrude through a loop at an end of each barrel swivel. A preferred method of constructing the fishing weight having comprises the steps of: drilling a hole through the body 1 along the axis defined by the cylindrical profile of the body 1; inserting the weight 5 into a hollowed out portion of the body created during the previous step; partially inserting one barrel swivel into each side of the hollowed out portion; and inserting the pins 4 perpendicularly to the aforementioned axis and a loop the concealed end of each barrel swivel. The weight 5 is counters the tendency of the body 1 to float and provides the desirable inertia of the fishing weight for achieving required distances and placement control when casting. Preferably, the pins 4 comprise a durable and corrosion resistance material such as stainless steel and the weight 5 comprises a dense material such as lead. Any other materials known in the art may be selected for either the pins or the weight.

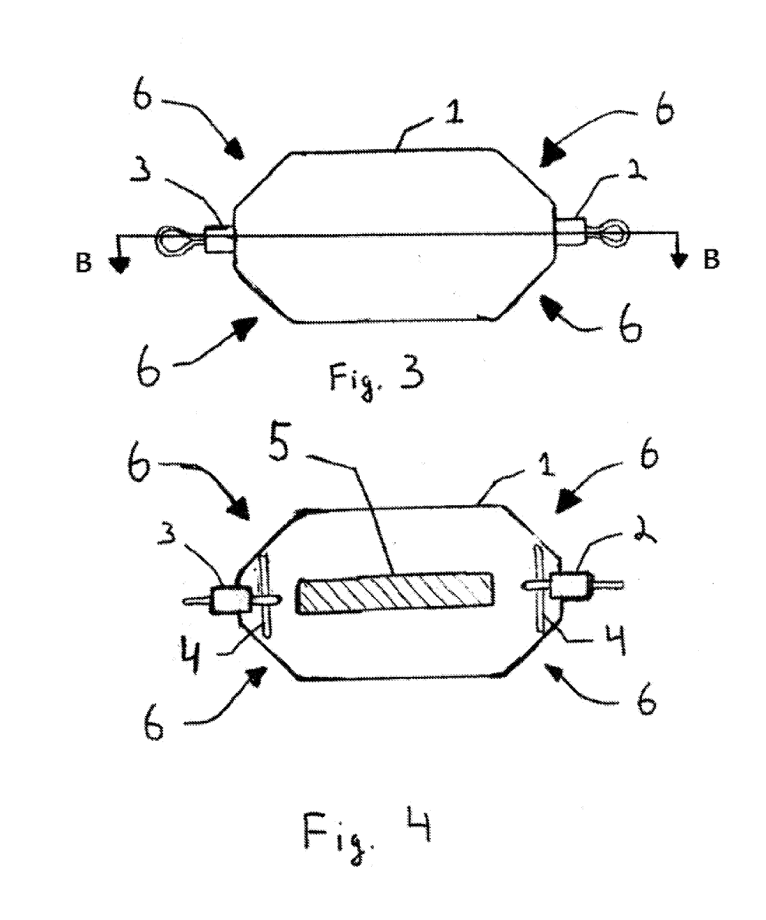

FIG. 3 is a side view, in accordance with a second embodiment of the fishing weight, of a cylindrical buoyant body 1 of the fishing weight having a swivel connector attached at each of two opposing ends and a profile 6, e.g. a chamfered or rounded edge, for reducing drag resistance and fouling as the fishing weight is dragged through water. FIG. 4 is a sectional view taken along the line B-B of FIG. 3, looking in the direction of the arrows, showing a weight within the cylindrical buoyant body and pins 4 for securing the swivels to the body 1 at the opposing ends. While a chamfer is shown in FIGS. 3-4, the profile 6 may take on any other desired shape. For example, the profile 6 may comprise one or more of a fillet, a chamfer, a bullnose, and/or any other shape or combination thereof. Preferably, the profile 6 serves to increase the probability of successfully catching fish, e.g. the profile 6 may be designed to reduce the risk of the weight becoming entangled in underwater material and/or may cause the bait and hook to spin as the tackle is dragged through the water thus increasing the chances of a fish striking. As can be appreciated from FIGS. 3-4, in some embodiments the buoyant body is generally elongate in shape and comprises an outer profile, e.g. a chamfer profile, at each of two ends which serve to reduce viscous drag forces while also reducing the likelihood of the fishing weight becoming entangled.

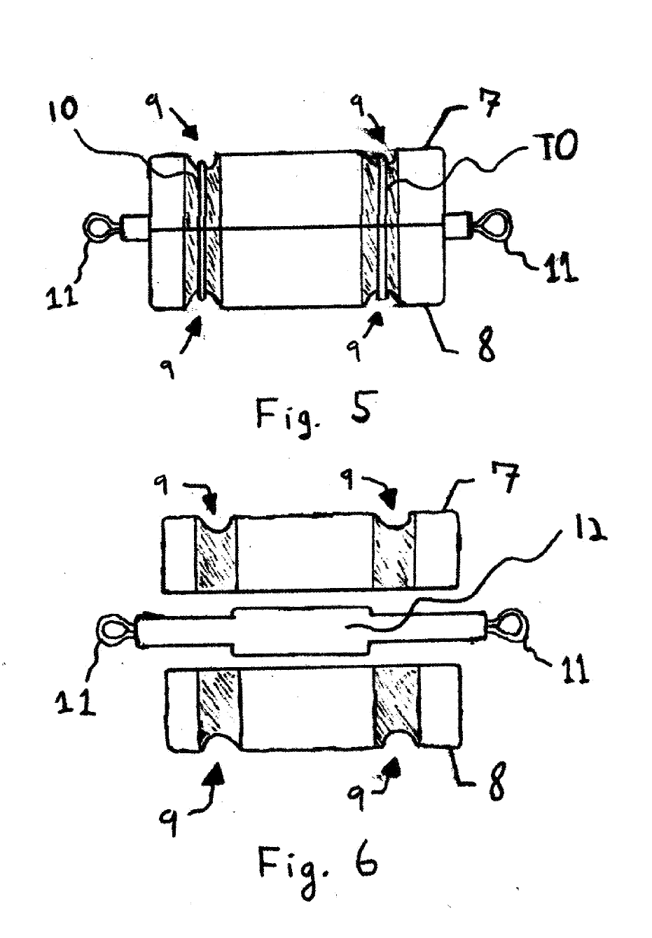

FIG. 5 is a side view, in accordance with a third embodiment of the fishing weight, of a first semi-cylindrical component 7 and a second semi-cylindrical component 8 which together form a cylindrical buoyant body of the fishing weight. Each semi-cylindrical component has a grooved region 9 for accepting bands 10 which join the components. Preferably, the bands 10 are biodegradable rubber bands or a similarly environmentally friendly material. Swivel connectors 11 protrude at opposite ends. FIG. 6 is an exploded side view, in accordance with a third embodiment of the fishing weight, showing the semi-cylindrical components separated and exposing a weight 12 which is normally secured and contained between the within the cylindrical buoyant body. Attached at opposite ends of the weight 12 are swivel connectors 11. The swivels may be attached to the weight 12 by any means known in the art, e.g. the swivels may be molded directly into the weight material. The bands 10 from FIG. 5 are not shown in FIG. 6. The size and density of the semi-cylindrical components are selected to optimize the buoyancy characteristics of the fishing weight apparatus as a whole. For example, if a fisherman is fishing in windy conditions then small semi-cylindrical components with a low density may be chosen, e.g. Styrofoam, in order to minimize wind resistance while maintaining the desirable buoyancy characteristics. In other situations, a fisherman may desire to use the fishing weight as a “bobber” and may accordingly choose semi-cylindrical components that cause the fishing weight apparatus to float on the surface of the water until a fish strike, at which point it is pulled underwater queuing fisherman to attempt to set the hook. It is a purpose of the fishing weight having optimized buoyancy characteristics disclosed herein to be quickly adaptable to current fishing conditions and/or needs.

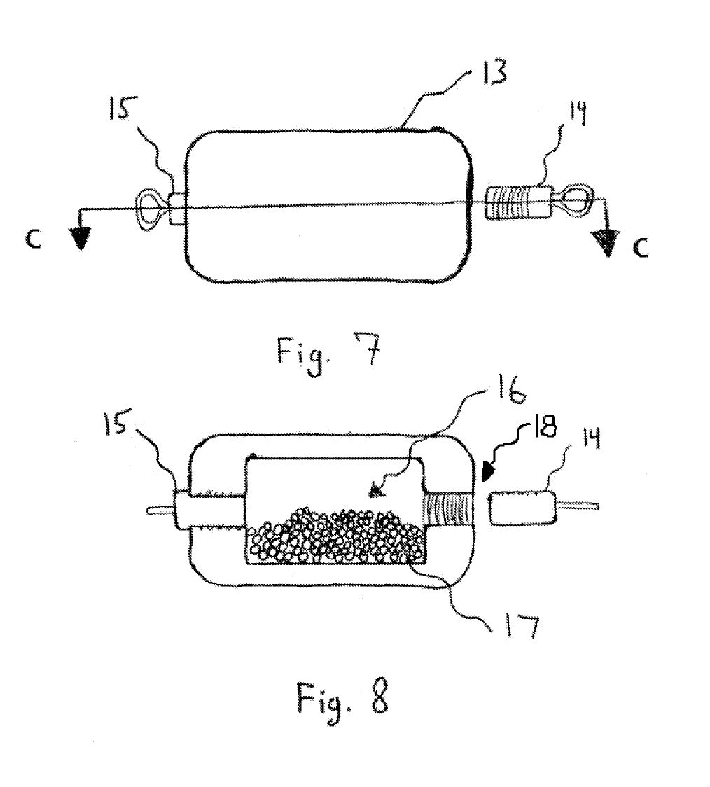

FIG. 7 is a side view, in accordance with a fourth embodiment of the fishing weight, of a cylindrical buoyant body 13 of the fishing weight having a first swivel connector 14 and a second swivel connector 15 at each of two opposing ends of the body 13. FIG. 8 is a sectional view taken along the line C-C of FIG. 7, looking in the direction of the arrows, showing a hollow space 16 containing removable weights 17, e.g. lead BB's, within the cylindrical buoyant body 13. In the illustrated embodiment, at least one of the swivel connector is removable to allow for the amount of total weight within the hollow space to be adjusted so as to achieve optimal buoyancy. Preferably, only the first swivel connector 14 is removable and the non-removable swivel connector has a visual indicator persuading the fisherman to attach the non-removable swivel to the fishing line and the removable swivel to the leader line. Such a configuration will reduce the probability of losing the fishing weight in the event that a swivel works itself lose over time. Preferably, the body 13 is made of a durable plastic material capable of having threads 18 cut into it such that at least one removable swivel connector, e.g. the first swivel connector 14, may be threaded into the body 13 creating a watertight seal. In other embodiments, the body is permeable by water, readily fills with water once casted onto the surface of the water, and has buoyancy provided by volume-to-density ratio of the chosen material. Moreover, the shape of the body 13 is not required to be cylindrical and, in fact, can be any shape necessary to achieve the desired effectiveness in any given situation. For example, the body 13 may be shaped, colored, and/or textured to induce spinning, flashing, reflecting, and/or vibration that either mimics small fish or prey.

The embodiments and descriptions described supra are for illustrative purposes only and are not intended to limit the scope of the fishing weight having optimized buoyancy characteristics. Therefore, while preferred and alternate embodiments have been illustrated and described, as noted above, many changes can be made without departing from the spirit and scope of the Fishing Weight Having Optimized Buoyancy Characteristics. Accordingly, the scope of the Fishing Weight Having Optimized Buoyancy Characteristics is not limited by the disclosure of these preferred and alternate embodiments. Instead, the scope of the Fishing Weight Having Optimized Buoyancy Characteristics should be determined entirely by reference to the claims. Furthermore, insofar as the description above and the accompanying drawings disclose any additional subject matter that is not within the scope of the claims below, the subject matter is not dedicated to the public and the right to file one or more applications to claim such additional inventions is reserved.

What is claimed is:

1. A fishing weight comprising:
a buoyant body having an inner cavity;
weight disposed within the inner cavity of the buoyant body;
connection means for connecting the fishing weight to a fishing line.

2. The fishing weight of claim 1, wherein the buoyant body is generally elongate in shape such that the buoyant body comprises a first end and a second end, and wherein at least one of the first end and the second end comprise an outer profile for reducing viscous drag forces.

3. The fishing weight of claim 1, wherein the buoyant body is cylindrical in shape and wherein the material from which the buoyant body is fabricated is selected from the group consisting of: synthetic cork material; natural cork material; Styrofoam; rubber;
and plastic.

4. The fishing weight of claim 1, wherein the connection means comprises:
a first barrel swivel affixed to a first end of the buoyant body; and
a second barrel swivel affixed to a second end of the buoyant body.

5. A fishing weight comprising:
at least two buoyant body elements configured for being adjoined to one another thereby forming an inner cavity;
a weight element configured for being enclosed within the inner cavity formed by the at least two buoyant elements;
connection means for connecting the fishing weight to a fishing line.

6. The fishing weight of claim 5, wherein the at least two buoyant body elements comprise at least one grooved region and wherein the at least two buoyant elements are configured for being maintained in an adjoined position by one or more bands resting within the at least one grooved region.

7. The fishing weight of claim 5, wherein the one or more bands are elastic.

8. The fishing weight of claim 5, wherein the connection means comprises:
a first barrel swivel affixed to a first end of the weight element; and
a second barrel swivel affixed to a second end of the weight element.

9. A fishing weight comprising:
a buoyant body having an inner cavity configured for enclosing one or more removable weight elements, wherein the buoyant body comprises at least one sealable opening through which the one or more removable weights may pass; and
connection means for connecting the fishing weight to fishing line.

10. The fishing weight of claim 9, wherein the connection means comprises at least one eyelet for coupling to a fishing line, the at least one eyelet being configured for being mechanically coupled to the at least one sealable opening of the buoyant body thereby enclosing the one or more removable weights within inner cavity of the buoyant body.

11. The fishing weight of claim 10, wherein at least one eyelet and the at least one sealable opening are configured for being threadably coupled to one another.

12. The fishing weight of claim 10, wherein at least one eyelet and the at least one sealable opening form a water tight seal.

13. The fishing weight of claim 9, wherein the one or more removable weight elements are lead.

14. The fishing weight of claim 9, wherein the buoyant body is made from a hard plastic.
